(19) United States
(12) Patent Application Publication
(10) Pub. No.: US 2013/0160302 A1
(43) Pub. Date: Jun. 27, 2013

(54) HARNESS FOR CARRYING PORTABLE CUTTING DEVICES, AND CUTTING DEVICES COMPRISING SUCH A HARNESS

(71) Applicant: Roger Pellenc, Pertuis (FR)

(72) Inventor: Roger Pellenc, Pertuis (FR)

(73) Assignee: PELLENC (Societe Annoyme), Pertuis (FR)

(21) Appl. No.: 13/639,160

(22) PCT Filed: Apr. 18, 2011
(86) PCT No.: PCT/FR11/00234

§ 371 Date: Nov. 23, 2012

(30) Foreign Application Priority Data
Apr. 21, 2010 (FR) 10/01688

(51) Int. Cl. A45F 5/00; B26B 27/00

(52) U.S. Cl. CPC A45F 5/00; B26B 27/00
USPC 30/275.4; 224/259

(57) ABSTRACT

A harness is provided for carrying portable cutting devices including an operating handle. Said harness comprises a front part and a back part that are interconnected by straps. At least the back part is also connected to a belt, that wraps around a user's waist The disclosed harness is characterized in that the front part includes a Y-shaped pendular suspension element, the upper branches of which are or can each be connected to one of the straps via their upper ends, and the lower leg of which has a connecting means at the lower end to swingingly attach the handle of a cutting device.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention concerns a harness for carrying portable cutting devices. It also relates to portable cutting devices equipped with such a harness.

The invention is in the field of portable cutting devices with long-handles used for agricultural

and forest activities, such as grass-cotter, edge cutter, brush cutter, hedge-trimmer and the like. The invention refers more specifically to a portable cutting device comprising a handle, a cutting head and an electric motor that are mounted to the distal part of this handle and a three-point suspension harness.

2. Description of Related Art Including Information Disclosed Under 37 CFR 1.97 and 37 CFR 1.98.

In the field of agricultural and forest activities, portable cutting devices are known for mowing, brush cutting or other similar work applied to the ground by an operator on foot. Such devices feature a long handle equipped, at its distal end, with a cutting tool, such as a rotary cutting tool or one with a chain driven in a closed loop. Motorization of the cutting tool is currently achieved by a thermal motor which is located at the proximal end of the handle or at the end of said handle, opposite the end on which the cutting tool is installed. Another solution consists of driving the cutting tool with an electric motor known to be lighter, which is advantageously carried by the handle in immediate proximity of the cutting tool. The handle is provided with one or several grips for grasping it and for letting the operator manipulate the device, by making sweeping and/or approaching movements of the cutting tool towards the vegetation to be cut, and a control handle installed on the proximal end of said handle.

The long feature of the handle is meant to let the operator perform cutting operations while standing and being away from the work area which is usually at ground level or essentially at the height of a human being. In the case of heavy, noisy and bulky thermal motors, operation of the device is difficult which leads to excessive fatigue of the operator. The handle being the carrier of the drive motor of the cutting tool at one of its end, the device is heavy and uncomfortable for the operator to carry, by making, its handling painful. To remedy this inconvenience, it is common to equip the handle with a carrying and support accessory at the belt, allowing the operator to position the device, by propping it against his hip or thigh, to facilitate carrying and handling the device; carrying it on the hip makes it possible to place the motor behind the user, and thus to direct exhaust fumes and noise backwards and away from said user.

With the same intention, it is common to use carrying harnesses that can be positioned on the operators' chests to relieve them of having not only to manipulate the device but also to have to carry it at arm's length. Such harnesses comprise, for example, a back part and a front part that are linked together by straps, they feature also a belt, and said front part, is fitted so it can be fastened to an attachment provided on the handle of the devices. Carrying harnesses of this kind are for instance described in documents EP0826324 (STIHL MASCHF ANDREAS) or WO2008147259 (HUSQVARNA AB et al.). These harnesses combine a back part suitable for being-placed against the operator's back, and a front part suitable for being placed against the chest and/or abdomen of the operator. These back and front parts are linked to each other by straps going over the operator's shoulders. These harnesses also comprise a belt and their front part is fitted so it can be fastened on an attachment provided on the handle of the devices. It has also been known to fit the back part of the harnesses so they can accept a drive motor linked to the cutting head of the device, for instance by means of a flexible connection.

To manipulate the device, the operator maintains the handle sideways to perform the movements for work and/or guidance of the cutting tool which allows him, if applicable, to rest the device against his flip or thigh to facilitate these operations.

### BRIEF SUMMARY OF THE INVENTION

The aim of the present invention is to make the operator more comfortable, by proposing such a harness with a set-up that provides comfortable carrying and optimized maneuverability of the device, and favors the operator's understanding of his work environment. The layout of the harness of the present invention is particularly adapted for the support of a long-handled device with electric motorization of the cutting tool, such as a rotary tool or with a closed loop driven chain.

More specifically, this harness is of the structurally organized kind to meet specific needs for ease of carrying on the back and for maneuverability of the device by the operator. According to a specific application of the harness proposed by the present invention, its structure provides particular interest in the context of an application for carrying and handling a cutting device with a long handle and electric motorization, according to which an electric motor is carried at the end of the handle in proximity of the cutting tool for its drive, while it is supplied with power from a source of electric energy mounted on the back part of the harness.

According to a first characteristic disposition of the invention, the front part of the harness features a pendular suspension presenting the general shape of a Y the upper branches of which are linked or capable of being linked, each, to a strap, through the intermediary of their upper end and the lower leg of which is provided, at its low end, with a linking means, or device to swingingly attach the handle of the cutting device.

According to an interesting embodiment, the harness of the present invention comprises a back part and a front part which are linked to each other by at least one pair of shoulder straps, at least the front part of the harness being attached to a belt and the front part of said harness which also comprises a pendular suspension in three points constituted by at least three straps of which two upper straps are linked or capable of being linked each to a shoulder strap, through the intermediary of their upper end, and a third lower strap linking the low end of the two upper straps and the low end of which is provided with a fastening means to attach it to an attaching element on the handle of a cutting device so as to enable the user to maneuver said cutting device horizontally as well as vertically.

The harness is laid out to be specifically usable for carrying and maneuvering a portable and motorized, cutting device with a long handle, by making it possible to structurally transfer, at least partially, the weight of the device to at least one of the operator's shoulders.

Advantageously, the adjacent ends of the three straps or components constituting the pendular suspension are linked, by means of a common connection device, with a possibility of varied orientation among each other. In other words, the carrying device presents itself in the form of an articulated Y at the point where these three branches come together.

Preferably, the common linkage system is constituted by a ring on which are attached, with a capability of sliding, the adjacent ends of the three branches forming the articulated Y.

To this effect, the adjacent ends of the three branches forming the articulated Y are for instance constituted in the form of sliding loops traversed by the linkage ring.

Thanks to this disposition, one obtains an instantaneous modification, during operations, of the relative orientation of the three parts forming the Y.

According to another characteristic disposition, the two upper branches of the front suspension device are equipped with means known as such, permitting an adjustment of their length, depending on the corpulence of the operators. According to another method of production, the lower strap of the carrying device is provided, with a means for adjusting its length depending on the operator's height.

Within the framework of a particularly adapted application of the harness to carrying and maneuvering a cutting device with a long handle and with electric motorization, the back part of the harness advantageously forms a support for a source of electric energy such as a rechargeable battery, linked to a connector on the electric motor of the cutting device. The back part of the harness, is notably provided with at least one support organ of such an energy reserve, constituted for example by a securing plate or plugs suitable for working together with socket elements equipping the energy source, such as rings working together with snap clasps or other similar fasteners.

The approach of the present invention consists, overall, in providing the front part of the harness with a front suspension device mounted, frontally on the harness in a pendular manner. This front suspension device is preferably easily removable. The front suspension device is engaged on the front part of the harness in areas laterally apart. Such connecting means use, for example, cooperating fastening elements such as rings, snap clasps, locking buckles or similar elements, and/or end pieces of front straps. The upper front straps are kept at lateral distance from each other on the front part of the harness through the intermediary of their upper end, their other ends or low end being joined to each other to the upper end of the lower strap. This lower strap is provided, at its bottom end, with a hook-up element to fasten it on an attachment element on the handle or connecting tube of the cutting device, to have said cutting device hang swinging from the pendular mounting of the front suspension device on the front part of the harness.

In the working position, the operator is able to maintain the device laterally using grips provided on the handle. Furthermore, and thanks to dispositions of the present invention, the device is supported on the back by the operator in a balanced manner by means, of the two distant grips of the front part, and in particular on both shoulder straps. This balancing of the stresses sustained by the operator makes it possible to secure the operating; conditions of the device and to relieve him by distributing these stresses on each of operator's, shoulders, with increased ease of operation and less fatigue. In addition, and because the attaching element is worn like a swing through the intermediary of the front part mounted in pendulum fashion on the harness, the operator can move the device from its lateral position to a frontal position in which the device is placed in front of him. This change of position of the device is obtained from the connection of the handle to the harness through the intermediary of the front part which is in frontal engagement on said part of the harness.

Thanks to the invention, the handle of the device, in its entirety, is capable of being moved from its lateral position to a position in front of the operator, and in reverse, depending on the nature of the work to be performed and the position of the operator in relation to the work area. By placing the entire device in the frontal position, the stresses distributed over the two shoulders of the operator can be better balanced, by relieving him of having to carry said, device at the end of his arm. Depending on the work area, the operator can move the device back and forth in frontal translation. Since the device is positioned in front of the operator, he can position himself facing the work area with the advantage of evenly distributing the stresses over both his shoulders and to have an optimized field of vision over the work area in front of him, laterally in a horizontal plane as much as vertically in relation to the ground. Raising the cutting device is easy to do, the induced stresses being primarily reflected and distributed over the operator's shoulders. The laboriousness of the work performed is reduced in comparison with a usual work position in which the device is carried laterally by the operator, and the frontal work position offers the operator better visibility of the work area and increased efficiency. The work perimeter is optimized, horizontally as well as vertically, thanks to the frontal placement of the device and its balanced carry by being supported on the shoulders of the operator.

According to a general characteristic of the present invention, a harness, as defined previously, featuring a back part, a front part, shoulder straps and a connecting belt between said back and front parts, is primarily remarkable in that the fastening element (a ring for example) provided on the handle of the device hangs swiveling on the harness through the intermediary of the suspension included in the front part of the latter. This front suspension is, in the aggregate, fitted for the pendular suspension of the device on the harness. Said suspension is particularly identifiable in that it is, in the aggregate, Y-shaped, the free ends of the branches of the Y being distant one from the other. The fastening element is mobile in frontal distance while remaining attached on the harness through the intermediary of the Y assembly.

According to a simple form of embodiment of the Y assembly, this associates a pair of upper straps which are engaged, through their high end, with the -shoulder-straps of the harness, at a lateral distance from each other. These high ends of the upper straps are opposed at their other ends through the intermediary of which they are assembled. More specifically, the upper straps are assembled one to the other at their opposite end to their high end of engagement on the shoulder straps of the harness by means of a lower suspension strap which is provided, at its opposite low end, with a fastening means.

The corresponding high ends of the upper straps are preferably engaged, on a respective shoulder strap of the front part of the harness to which they are assigned.

According to a preferred form of embodiment, at least any one of the upper straps and the suspension strap are of adjustable length, to allow the operator to adjust their length to the desired comfort for his working position and/or the nature of the work to be performed.

The pendular suspension can be advantageously mounted in removable manner on the front part of the harness, to allow the operator to easily install, or inversely to remove, said suspension from the front part of the harness.

The front straps are preferably engaged on the front part of the harness through the intermediary of cooperating fastening elements that are easily reversible. These cooperating fastening elements are respectively assigned to each of the front straps and to the front part of the harness in its laterally distant engagements.

According to a form of embodiment, the front straps are independent, straps, the free ends of which are each engaged on the front end of the harness and of which the other ends are integral with or attached one to the other.

According to another form of embodiment, the upper branches of the pendular suspension are constituted by the two ends of a single strap which is mounted so as to slide on the junction element.

### BRIEF DESCRIPTION OF THE DRAWINGS

The above aims, characteristics and advantages and still others, will become clearer from the description below and the attached drawings in which:

FIG. 1 is an exploded perspective view of a harness according to a preferred form of embodiment of the present invention.

FIG. 2 is an assembled frontal illustration of the harness shown in FIG. 1.

FIGS. 3,4 and 5 illustrate different work positions performed by an operator by means of a cutting device suspended from the claimed harness.

### DETAILED DESCRIPTION OF THE INVENTION

Below is described, an advantageous but by no means limiting example of embodiment of the suspension harness according to the invention.

In the following description and in the Claims the words “upper”, “lower”, “high”, “low” are used in reference to the position, of the device in operation; these terms do not have any limiting character.

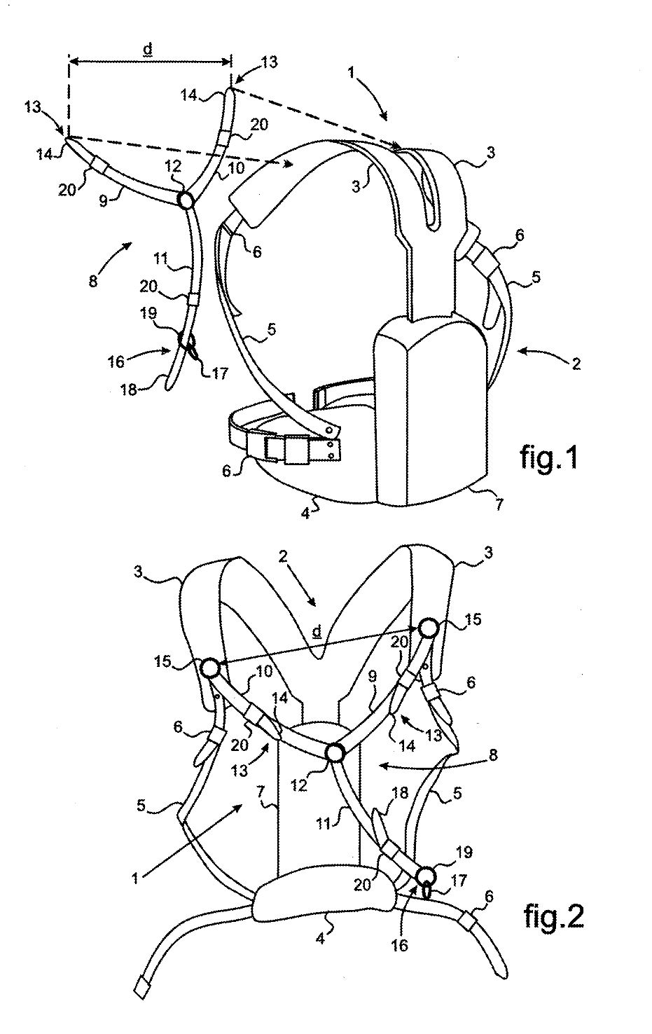

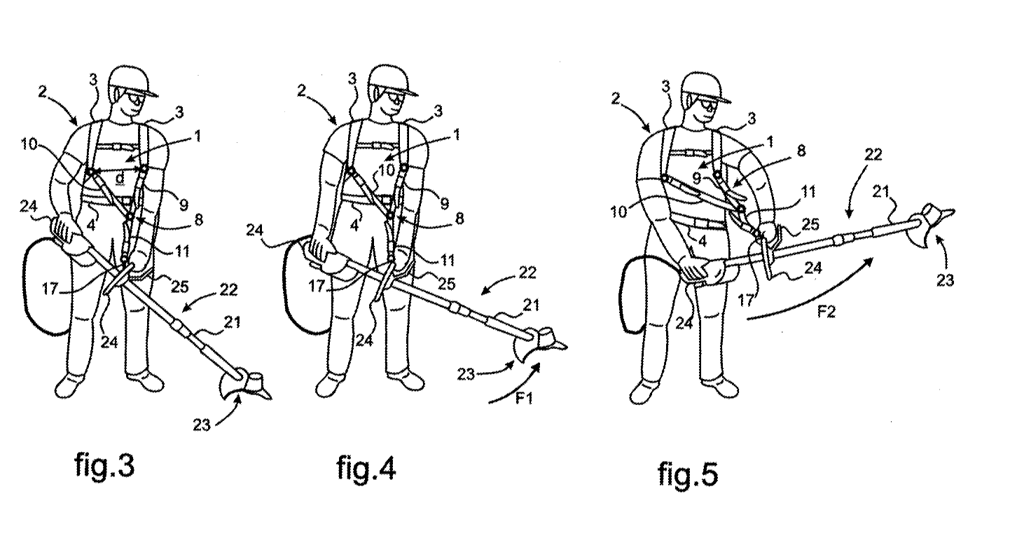

FIGS. 1 and 2 represent a harness fitted to be carried by an operator on foot, with a view to support a portable cutting device with a long handle, hand-guided by the operator. Reference is also, made to FIGS. 3 to 5 which illustrate different possible positions of the cutting device supported by the harness, in operation, and which show an operator equipped with this harness and who carries such a device in a working situation.

The harness features primarily a front pan or frontal part 1 and a dorsal back part 2 which are intended to be placed respectively on the chest and the back of the operator. These front 1 and back 2 parts are connected one to the other by a pair of shoulder straps 3 which extend between the front and the back of the harness from one to the other of the front part 1 and the back part 2. These shoulder straps 3 are shaped to rest on the shoulders of an operator OP. The harness also features a belt 4 intended to surround the waist of the operator. The back part 2 is anchored to this belt 4. The front part 1 can be connected to side straps 5 anchored on the shoulder straps 3 and on the belt 4 in the back area of the belt. These side straps 5 are fitted to extend from the front part 1 to the back part 2 by extending over the operator's sides.

The belt 4 and the side straps 5 are preferably provided with elements 6, known as such, for regulating their length, by sliding and locking for instance.

The back part 2 is advantageously fitted for carrying a source of electric energy 7, for the power supply of an electric motor for operation of the cutting tool that the device comprises. The motor and the cutting tool are placed at the distal part of the handle, to enable the operator to work at the ground or at human height while standing upright, as illustrated in FIGS. 3 to 5.

According to a characteristic disposition of the invention, the front part of the harness comprises a pendular suspension 8. This pendular suspension is, in the aggregate, shaped, like a Y, each of its component parts, leg and branches are formed of straps 9, 10, 11, linked to each other at. their adjacent end, in the connection area of said components of the Y. Such an assembly can be advantageously achieved by means of an appropriate connecting element, for example constituted by a ring 12, which allows a sliding attachment of the ends thus, assembled of said component parts on the connection ring. The two branches of the Y are formed by two upper front straps 9,10, the high end 13 of which is attached or capable of being attached to the front part 1. The high ends 13 of the front straps 9, 10 are more precisely attached to the front part of a respective shoulder strap 3, at lateral distance d one from the other. Such an attachment is achieved, in a manner known as such, by means of cooperating, easily reversible fastening elements 14, 15 which are respectively assigned to each of the upper front straps 9,10 and to shoulder straps 3. Such fastening elements 14,15, are for example constituted by a ring cooperating with the free end of the front straps, or other cooperating elements indifferently assigned to the front straps 9, 10 and/or the shoulder straps 3.

The leg of the Y is formed by a lower suspension strap 11 engaged on the connecting element 12 of the straps 9, 10, of the suspension 8. The free end 16 of the lower suspension strap 11 is provided with an attachment element 17 such as fitted in form of a snap clamp or similar. This fastening element 17 is meant to connect the harness to a suspension element equipping the middle portion of the handle of the device, with a view to its swinging support, by the operator, obtained from the pendular mounting of the suspension 8 on the front part 1.

The fastening element 17 is mounted on the suspension strap 11, either in a fixed manner or easily removable, by means of cooperating elements 18, 19 which are respectively assigned to the suspension strap 11 and the fastening element 17. Such cooperating elements 18,19 are, for example, constituted, by a ring working together with the low end of the suspension strap 11, or other cooperating elements that are indifferently assigned to the suspension strap 11 and the fastening element 17. The upper elements 9, 10 and/or the lower element 11 of the pendular suspension 8 are each advantageously provided with elements 20 for adjusting their length, by sliding or locking, for example. The suspension 8 put together in this manner is mounted, frontally and preferably in a removable manner, on the front part of the harness, as it is worn by the latter in pendular fashion.

According to another embodiment, the two upper branches or elements 9,10 of the pendular suspension can be constituted by the two ends of a single strap mounted so that it slides on the connecting element 12.

The invention concerns also portable cutting devices 22 such as grass cutters, edge- trimmers, brush cutters, hedge cutters, featuring a handle or elongated connecting tube 21, a cutting tool 23 and an electric motor installed, at the distal end of this handle which is equipped, in its middle part, with one or several operating handles 24 and a fastening element for the pendular suspension of said device at the lower end of the suspension 8 of the harness described above. The control handle 26 for operating the electric motor 27 driving the cutting head 23 of the device, is installed at the top or at the proximal part of the connecting tube or handle 21. Advantageously, the electric motor may be constituted by a brush less electric motor of high power (at least 800 W) and high efficiency, not requiring any forced cooling and which is also relatively lightweight.

According to one embodiment, the handle or elongated connecting tube 21 of the portable cutting device is constituted by at least two tubular parts that are assembled in telescopic manner.

Advantageously, the management of the operation of the electric drive motor of the cutting tool 23 is performed by an electronic card located, in the control handle 26 of said motor, the control handle itself being installed in the high or proximal part of the handle of the device, as indicated above.

By referring to figures 3,4, and 5, one will understand the notions of front, back, and lateral for the position of the components relative to the orientation of the harness while it is being worn by the operator. The same goes for the notions of dorsal, ventral and frontal, this latter notion designating a direction facing the front part of the harness while being, worn by the operator.

On FIGS. 3 to 5, the operator wearing the harness is in a working situation. The suspension 8 is fastened to the harness and supports the handle 21 of the device 22 through the intermediary of the fastening element 17. In the example of application shown, the device 22 is a rotary mower/brush cutter equipped with a rotary, electrically driven cutting tool 23. Such an application, although particularly appropriate, is given as an example and the harness of the present invention is likely to be used for any type of long-handled device with a cutting tool at one end.

On FIG. 3, the operator manipulates the device 22, so that the cutting tool 23 is sweeping the ground. In this position, operation of the device 22 by the operator is achieved by means of the control handles 24 usually mounted on the long handle 22 of the device and, through the intermediary of the harness. In this working position, the device 22 is carried by the operator sideways in the habitual manner. An accessory support element 25 is likely to be provided on the long handle 22 to prevent the tool 23 from coming too close to the operator's, legs. The assistance provided by the harness improves the operator's comfort, a major part of the weight, of the device being distributed over his two shoulders, from the attachment of the suspension 8 to the front part 1 in two points laterally distant d and in particular on the two shoulder straps.

On FIG. 4, the device 22 being supported in a balanced manner through the intermediary of the pendular suspension 8 on the front part 1 of the harness, the operator can move the device forward (F1) in order to work above the ground by performing an operation of mowing, comprising in particular not only sweeping movements in the horizontal, plane but also upward movements. The device is still carried in lateral position by the operator. The frontal displacement (F1) of the device made possible by the suspension 8, because of its balanced condition, lets the operator benefit from the harness to relieve him of having to carry the device 32 at arm's length, its weight being distributed on his shoulders.

On FIG. 5, the balanced support of the device 22 lets the operator place it frontally (F2), the operator standing behind the device 22 and facing the work area. Just the same as for the working position shown in FIG. 4, the weight of the device 22 is primarily supported by the operator's shoulders, his arms being essentially used to manipulate the device. With the operator having the ability to face the working area while holding the device in front of him, he is afforded a better view of this working area. The electric motorization of the cutting tool 23 allows placement of the drive motor on the front side of the operator without causing him discomfort as would be the case with the heat and noise of the motor or the weight of the entire assembly or even by gas exhaust in the case of a combustion engine driving the device 22.

1. Harness for carrying portable cutting tools featuring an operating handle, this harness being of the type comprising a front part and a back part, connected by shoulder straps, at least said back part being also attached to a belt intended to go around a user's waist, characterized in that the front part features a pendular suspension presenting the general shape of a Y, the upper branches of which are connected or suitable for being connected, each one, to one of the shoulder straps through the intermediary of their high end and the lower leg of which is provided, at its lower end, with a connecting means for the balancing attachment of the handle of a cutting device.

2. Harness according to claim 1, characterized in that said pendular suspension is constituted by at least three straps, two upper straps of which are connected or capable of being connected, each one, to one of the shoulder straps, through the intermediary of their high end and a third lower strap connecting the low end of the two upper straps and the lower end of which is provided with a connecting means for fastening it to an attachment element provided on the handle of the cutting device.

3. Harness according to claim 1, characterized in that the upper branches and lower leg of the pendular suspension are connected one to the other, by a common connection system.

4. Harness according to claim 3, characterized in that the common connection, system is constituted by a ring on which are fastened, with a sliding capability, the adjacent ends of the upper branches and lower leg forming said pendular suspension.

5. Harness according to claim 1, characterized in that the pendular suspension is fastened, in a removable manner, on the front part of said harness.

6. Harness according to claim 1, characterized in that the upper branches and/or the lower leg of the pendular suspension are provided with regulating means for adjusting their length.

7. Harness according to claim 1, characterized in that its back part is fitted to allow the installation of a source of energy for driving the motor operating the tool of the cutting device hanging on said harness.

8. Harness according to claim 1, characterized in that the upper branches of the pendular suspension are constituted by the two ends of one and the same strap which is mounted as sliding on the connecting element.

9. Portable cutting device featuring a handle, a cutting tool and an electric motor installed at the distal end of this handle which is equipped, in its middle part, with a fastening element and one or several control handles, characterized in that said device is equipped with a harness according to claim 1, so as to enable the balancing suspension of said device at the lower end of the pendular suspension of said harness.

10. Portable cutting device according to claim 9, characterized in that the handle of said device is constituted by at least two parts assembled in a telescopic manner.

11. Portable cutting device according to claim 9, characterized in that an electronic card for management of the operation, of the electric motor is located in the control handle of the motor installed on the high part of the handle of said device.
